(19) United States
(12) Patent Application Publication
(10) Pub. No.: US 2015/0292596 A1
(43) Pub. Date: Oct. 15, 2015

(54) CRANKSHAFT DAMPER

(71) Applicant: Caterpillar Inc., Peoria, IL (US)

(72) Inventors: James J. Streicher, East Peoria, IL (US); Jason V. Farowe, Brimfield, IL (US); David M. Indire, Peoria, IL (US); James L. Jenkins, Rome, IL (US)

(73) Assignee: Caterpillar Inc., Peoria, IL (US)

(21) Appl. No.: 14/250,500

(22) Filed: Apr. 11, 2014

(51) Int. Cl. F16F 15/28

(52) U.S. Cl. CPC F16F 15/283; F16F 2226/04

(57) ABSTRACT

A crankshaft damper for a crankshaft is provided. The crankshaft damper includes a housing including a center opening configured to receive the crankshaft therein. The crankshaft damper includes a cover plate removably coupled to the housing. The housing and the cover plate enclose an annular chamber therebetween. The crankshaft damper further includes an inertia member disposed within the annular chamber. The cover plate includes an outer diameter surface located at an outer diameter thereof. The outer diameter surface defines an annular outer edge. The crankshaft damper further includes a plurality of outer through-holes formed as notches on the annular outer edge of the cover plate. Each of the plurality of outer through-holes extends inward along the outer diameter of the cover plate. Further, each of the plurality of outer through-holes receives a fastener therein to couple the cover plate to the housing.

### TECHNICAL FIELD

The present disclosure relates to a crankshaft damper, and more particularly to a cover plate of the crankshaft damper.

### BACKGROUND

Some internal combustion engines may include a vibration damper which can be configured to absorb torsional vibrations and/or axial vibrations generated during an operation of the internal combustion engines. While vibration dampers may be effective component in terms of absorbing vibrations and facilitating the operation of internal combustion engines, conventional vibration dampers may be characterized by disadvantages and/or difficulties in fabrication, manufacturing, assembly, and/or installation.

U.S. Pat. No. 8,628,425 discloses a torque fluctuation absorber. The torque fluctuation absorber includes a damper portion absorbing a torque fluctuation between the output shaft and the input shaft with an elasticity thereof, and a limiter portion arranged on the power transmission path from the damper portion to the input shaft, configured to slip when the torque fluctuation by a torsion between the output shaft and the input shaft equals or exceeds a predetermined torque defined to absorb at the damper portion. The damper portion includes a center plate transmitting a rotational power to the limiter portion, side plates receiving the input of the rotational power from the output shaft, an elastic member absorbing the torque fluctuation caused by the torsion between the center plate and the side plates. The side plates directly or indirectly connect to a flywheel that connects to the output shaft at a circumferential portion outward in a radial direction relative to the damper portion.

The present disclosure is directed to mitigating or eliminating one or more of the drawbacks discussed above.

### SUMMARY

In one aspect, the present disclosure provides a crankshaft damper for a crankshaft. The crankshaft damper includes a housing including a center opening configured to receive the crankshaft therein. The crankshaft damper includes a cover plate removably coupled to the housing. The housing and the cover plate enclose an annular chamber therebetween. The crankshaft damper further includes an inertia member disposed within the annular chamber. The cover plate includes an outer diameter surface located at an outer diameter thereof. The outer diameter surface defines an annular outer edge. The crankshaft damper further includes a plurality of outer through-holes formed as notches on the annular outer edge of the cover plate. Each of the plurality of outer through-holes extends inward along the outer diameter of the cover plate. Further, each of the plurality of outer through-holes receives a fastener therein to couple the cover plate to the housing.

In another aspect, the present disclosure provides a cover plate for a crankshaft damper. The cover plate includes a central opening configured to receive a crankshaft therein. The cover plate includes a plurality of outer through-holes formed as notches on an annular outer edge of the cover plate. Each of the plurality of outer through-holes extends inward along an outer diameter of the cover plate. Further, each of the plurality of outer through-holes is configured to receive a fastener therein to couple the cover plate to a housing of the crankshaft damper.

In another aspect, the present disclosure provides a method of manufacturing a cover plate of a crankshaft damper from a blank plate. The method includes piercing a portion of the blank plate proximate a blank outer surface thereof. The method includes machining a first outer through-hole around the pierced portion. The first outer through-hole is formed as a notch on the blank outer surface of the blank plate. The method further includes machining subsequent outer through-holes at angular intervals along the blank outer surface of the blank plate in a single continuous cutting operation.

Other features and aspects of this disclosure will be apparent from the following description and the accompanying drawings.

### BRIEF DESCRIPTION OF THE DRAWINGS

FIG. 1 illustrates a crankshaft damper assembly, according to an embodiment of the present disclosure;

FIG. 2 a perspective view of a crankshaft damper of FIG. 1, according to an embodiment of the present disclosure;

FIG. 3 illustrates a front view of the cover plate of FIG. 2;

FIG. 4 illustrates a front view of the cover plate, according to another embodiment of the present disclosure;

FIG. 5 illustrates a front view of the cover plate, according to yet another embodiment of the present disclosure;

FIG. 6 illustrates a flowchart for a method of manufacturing the cover plate, according to an embodiment of the present disclosure; and

FIGS. 7, 8 and 9 illustrate schematic views of an exemplary manufacturing process to manufacture the cover plate of the present disclosure.

### DETAILED DESCRIPTION

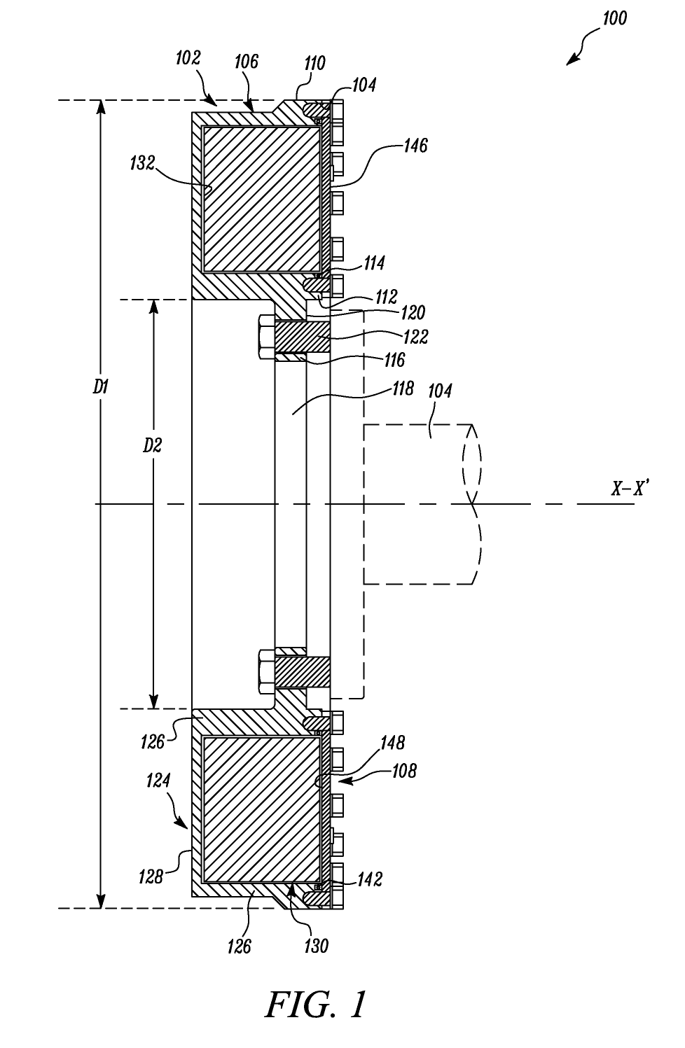

The present disclosure relates to a crankshaft damper, and more particularly to a cover plate of the crankshaft damper. References will now be made in detail to specific embodiments or features, examples of which are illustrated in the accompanying drawings. Wherever possible, the same reference numbers will be used throughout the drawings to refer to the same or like parts. FIG. 1 illustrates a cross-sectional view of a crankshaft damper assembly 100 having an axis X-X′. The crankshaft damper assembly 100 includes a crankshaft damper 102 mounted on a crankshaft 104 (shown in dashed lines). The crankshaft 104 may be associated with a powertrain (not shown) of a power source (not shown). The power source may be an internal combustion engine, an electric motor, or the like. The internal combustion engine may be a compression ignition engine that combusts diesel fuel. Alternatively, the internal combustion engine may include a spark ignition engine that is configured to combust gasoline or other fuels such as ethanol, bio-fuels, or the like. The internal combustion engine may also be a dual fuel or a gaseous fuel engine.

The crankshaft damper 102 includes a housing 106 and a cover plate 108 removably coupled to the housing 106. The housing 106 can be substantially solid, and can be defined as a generally ring or disk shaped member including a chamber housing portion 124, a hub 116, and a center opening 118. The housing 106 may be manufactured using methods including not limited to casting, machining, and the like. The chamber housing portion 124 of the housing 106 can be defined as a shroud or a portion of the housing 106 which forms and at least partially encloses an annular chamber 130, as further disclosed herein. The housing 106, and the chamber housing portion 124 thereof, includes an external circumference 110 which defines an external diameter D1 of the housing 106 which is adjacent to an external diameter of the annular chamber 130. The chamber housing portion 124 of the housing 106 also includes an internal circumference 112 which defines an internal diameter D2 of the chamber housing portion 124 adjacent to the internal diameter of the annular chamber 130. The chamber housing portion 124further includes a plurality of bores 114 extending into the interior of the housing 106. The bores 114 are disposed circumferentially along and spaced throughout the external and the internal circumference 110, 112 of the chamber housing portion 124 surrounding the annular chamber 130. The bores 114 may be internally threaded. In one embodiment, the chamber housing portion 124 can include a pair of axial portions 126 extending axially along the axis X-X′ as well as a transverse portion 128 which extends transversely between the pair of axial portions 126. One of the axial portions 126 is located on the external circumference 110 of the housing 106, while the other axial portion 126 is located on the internal circumference 112 of the chamber housing portion 124. The transverse portion 128 is disposed at an end of each of the pair of first plates 126. In the presently discussed embodiment, the bores 114 can be formed to extend into the pair of axial portions 126. In one example, the chamber housing portion 124 can be defined as a formed plate. In addition to other components of the housing 106 as defined herein, the chamber housing portion 124 may be formed via a casting process, or alternatively, may be formed by stamping, or deep drawing a single plate such that the singular plate may define, at least in part, a substantially U-shaped cavity which may define the annular chamber 130. Alternatively, the various portions of the housing 106 as disclosed herein may be manufactured separately and then coupled to each other by any method known in the art.

As further illustrated in FIG. 1, the housing 106 includes a hub 116, and a center opening 118. The hub 116 is a substantially ring shaped, interior portion of the housing 106 that defines the interior portion of the housing 106 extending from the internal circumference 112 of the chamber housing portion 124 radially inwardly toward the axis X-X′ to surround and define the center opening 118. As shown in FIG. 1, the center opening 118 is defined about the axis X-X′. The hub 116 includes a plurality of circumferentially spaced bolt-holes 120. The center opening 118 is configured to receive the crankshaft 104 associated with the powertrain of the power source (not shown). The crankshaft damper assembly 100 can employ a plurality of bolts 122 can be disposed through and received within the plurality of circumferentially spaced bolt-holes 120 defined on the hub 116 to couple the crankshaft 104 to the crankshaft damper 102. The bolts 122 may be one of threaded bolts and screws commonly known in the art.

As shown in FIG. 1, the chamber housing portion 124 of the housing 106, and the cover plate 108 enclose an annular chamber 130 therebetween. The annular chamber 130 is a substantially ring shaped annular cavity disposed adjacent the external circumference 110 of the housing 106. An inertia member 132 is disposed within the annular chamber 130. The inertia member 132 can be a substantially ring shaped or toroidal body and can have a shape and/or geometry configured to be received within the annular chamber 130. In one embodiment, he inertia member 132 can be an integral disk. Alternatively, the inertia member 132 may be formed by stacking a plurality of inertial plates and/or disks one against another, and fastening them together using conventional methods like welding, adhesives, fasteners and the like.

In one embodiment, the annular chamber 130 can also include a viscous fluid, wherein the interior surface(s) of the chamber housing portion 124 which define the annular chamber 130 can be formed or dimensioned to include any one or more of various clearances, reservoirs, or other spaces within the annular chamber 130 within which the viscous fluid may be filled, coated, or may be retain and/or fluidly communicated between the interior surface(s) of the chamber housing portion 124 and the inertia member 132 housed therein.

In an embodiment, the crankshaft damper 102 may further include one or more sealing members 142 such as an 0-ring provided between the housing 106 and the cover plate 108. With this configuration, the one or more sealing members 142 can be configured to seal the inertia member 132 and the viscous fluid within the annular chamber 130 such that the inertia member 132 is configured to rotate relative to the crankshaft damper 102 which is coupled to the crankshaft 104 for rotation therewith and a viscosity of the viscous fluid between surfaces of the inertia member 132 and the housing 106 produces a damping effect. Thus, the crankshaft damper 102 can be defined as a viscous-type crankshaft damper.

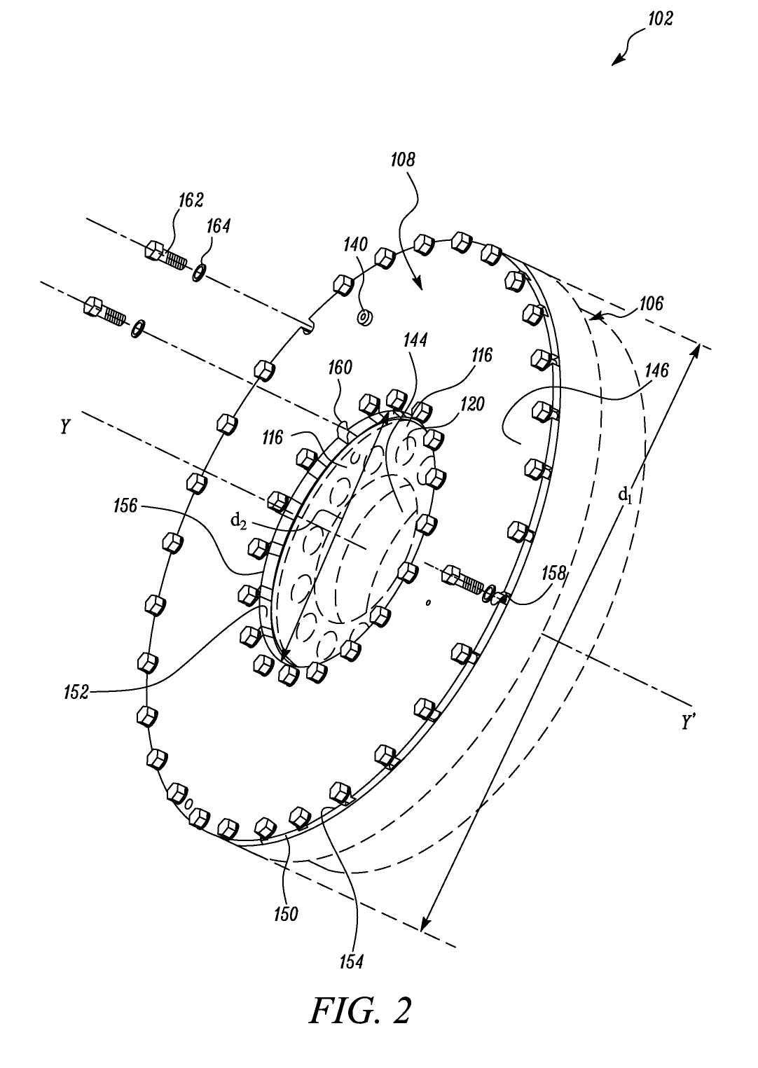

FIG. 2 illustrates a perspective view of the crankshaft damper 102 of FIG. 1, according to an embodiment of the present disclosure. The cover plate 108 is a substantially circular plate including a central opening 144. The central opening 144 of the cover plate 108 is disposed about a central axis Y-Y′ of the cover plate 108. When the cover plate 108 is coupled to the housing 106 (shown in dashed lines), the axes X-X′ (shown in FIG. 1) and the central axis Y-Y′ coincide with each other. Thus, the center opening 118 of the housing 106, the hub 116 and the central opening 144 of the cover plate 108 are coaxially aligned. As shown in FIG. 2 and further shown in FIG. 1, the cover plate 108 includes a first surface 146 and a second surface 148. The first surface 146 and the second surface 148 may be opposing, and substantially parallel to each other. The second surface 148 abuts the housing 106. The cover plate 108, as well as the first and second surfaces 146, 148 thereof, can include an annular outer edge 154 and an annular inner edge 156, wherein the annular outer and inner edges 154 can be substantially concentric and can be coaxial with respect to the central axis Y-Y′. The annular outer edge 154 can be formed by an outer diameter surface 150 which can define an outer diameter dl of the cover plate 108, and the annular inner edge 156 can be formed by an inner diameter surface 152 of the cover plate 108 which can surround and define the central opening 144 as well as an inner diameter d2 of the cover plate 108. Further, the outer diameter d1 and the inner diameter d2 are also concentric to each other.

The cover plate 108 includes a plurality of first or outer through-holes 158 formed as notches in the annular outer edge 154. Each of the plurality of the outer through-holes 158 extends inward from the outer diameter surface 150 and annular outer edge 154 towards the annular inner edge 156 of the cover plate 108. In an embodiment, an array of the outer through-holes 158 can be positioned to extend inward from the outer diameter surface 150 at equally spaced intervals along, and throughout the annular outer edge 154 of the cover plate 108. Additionally, the plurality of outer through-holes 158 can be configured to receive and retain a plurality of fasteners 162, as further discussed herein, and can be formed as inward extensions of the outer diameter surface 150 to define cut-outs or voids which form openings in the annular outer edge 154 of the cover plate 108, as further discussed herein. As such, the surfaces which form the outer through-holes 158 and openings thereof can be contiguous with the outer diameter surface 150 of the cover plate 108. Further, the cover plate 108 includes a plurality of second or inner through-holes 160 formed as notches in the annular inner edge 156 of the cover plate 108. Each of the plurality of the inner through-holes 160 extends inward from the inner diameter surface 150 and the annular inner edge 156 of the cover plate 108 towards the annular outer edge 154 of the cover plate 108. In an embodiment, an array of the inner through-holes 160 can be positioned to extend inward from the inner diameter surface 152 at equally spaced intervals along, and throughout the annular inner edge 156 of the cover plate 108. Additionally, the plurality of inner through-holes 160 can be configured to receive and retain a plurality of fasteners 162, as further discussed herein, and can be formed as inward extensions of the inner diameter surface 152 to define cut-outs or voids which form openings in the annular inner edge 156 of the cover plate 108, as further discussed herein. As such, the surfaces which form the inner through-holes 160 and openings thereof can be contiguous with the inner diameter surface 152 of the cover plate 108. The outer and the inner through-holes 158, 160 are configured to be aligned to the corresponding bores 114 disposed on the housing 106 and receive respective fasteners 162 for coupling the cover plate 108 to the housing 106. The fasteners 162 may be one of threaded bolts or screws provided with respective washers 164. Further, the inner and the outer through-holes 158, 160 receive the respective threaded fasteners 150 therein. In an embodiment, the inner and the outer through-holes 158, 160 may be substantially similar and thus receive substantially similar threaded fasteners 150 therein.

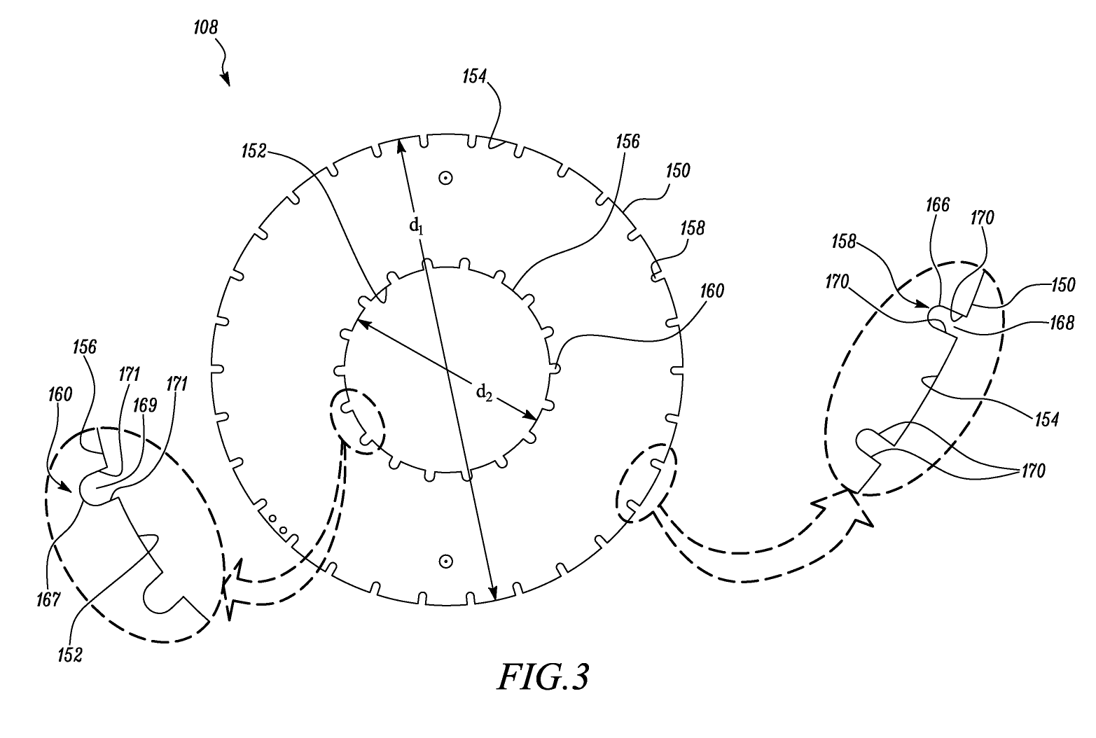

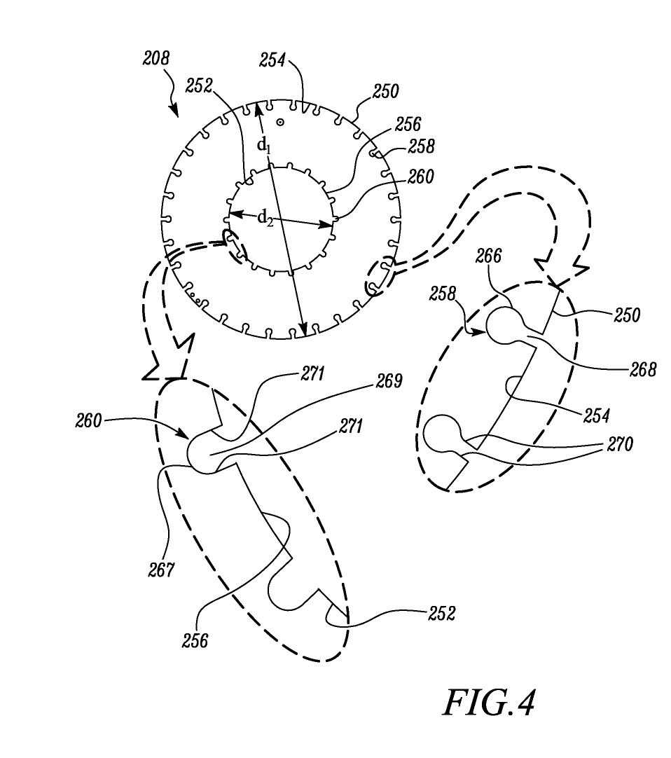

FIG. 3 illustrates a front view of the cover plate 108, according to an embodiment of the present disclosure. Referring to the detailed view of FIG. 3, each of the plurality of the outer through-holes 158 includes a fastener retaining surface 166, wherein each fastener retaining surface 166 can be open to and connected with the outer diameter surface 150 on opposing sides of the opening or channel 168, which, in one embodiment, can be via lateral surfaces 170, as further discussed herein. A profile of the fastener retaining surface 166 may correspond to a profile of the respective fastener 162 which is received therein. The fastener retaining surface 166 may define a substantially arcuate profile, a circular profile, a polygonal profile, and the like. In an embodiment, each of the outer through-holes 158 may be formed as an inward extension of the outer diameter surface 150 to each define a channel 168 extending from the annular outer edge 154 towards the fastener retaining surface 166. Thus, the channel 168 forms an opening in the annular outer edge 154 of the cover plate 108. Hence, as provided above, each fastener retaining surface 166 (266, 366) can be contiguous with the outer diameter surface 150 (250, 350) of the cover plate 108 (208, 308), which in the embodiments illustrated in FIG. 3 and FIG. 4, can be via lateral surfaces 170, 270, as further discussed herein. In an exemplary embodiment, the fastener retaining surface 166 may define a substantially arcuate profile having an arc length substantially equal to or less than 180 degrees such that the fastener retaining surface 166 forms a semi-circle. The channel 168 may be defined by a pair of opposing lateral surfaces 170 that extend between ends of the fastener retaining surface 166 and the outer diameter surface 150. Thus, each of the outer through-holes 158 may be shaped as a U-shaped notch (shown in FIG. 3).

As further shown in FIG. 3, each of the plurality of the inner through-holes 160 includes a fastener retaining surface 167, wherein each fastener retaining surface 167 can be open to and connected with the inner diameter surface 152 on opposing sides of the opening or channel 169, which, in one embodiment, can be via lateral surfaces 171, as further discussed herein. A profile of the fastener retaining surface 167 may correspond to a profile of the respective fastener 162 which is received therein. The fastener retaining surface 167 may define a substantially arcuate profile, a circular profile, a polygonal profile, and the like. In an embodiment, each of the inner through-holes 160 may be formed as an inward extension of the inner diameter surface 152 to each define a channel 169 extending from the annular inner edge 156 towards the fastener retaining surface 167. Thus, the channel 169 forms an opening in the annular inner edge 156 of the cover plate 108. Hence, as provided above, each fastener retaining surface 167 (267, 367) can be contiguous with the inner diameter surface 152 (252, 352) of the cover plate 108 (208, 308), which in the embodiments illustrated in FIG. 3 and FIG. 4, can be via lateral surfaces 171, 271, as further discussed herein. In an exemplary embodiment, the fastener retaining surface 167 may define a substantially arcuate profile having an arc length substantially equal to or less than 180 degrees such that the fastener retaining surface 167 forms a semi-circle. The channel 169 may be defined by a pair of opposing lateral surfaces 171 that extend between ends of the fastener retaining surface 167 and the inner diameter surface 152. Thus, each of the inner through-holes 160 may be shaped as a U-shaped notch (shown in FIG. 3).

FIG. 4 illustrates a front view of the cover plate 208, according to another embodiment of the present disclosure. A detailed view of the outer diameter surface 250 of the cover plate 208 is provided for ease of explanation herein. The fastener retaining surface 266 of each outer through-hole 258 as shown in the embodiment illustrated in FIG. 4 can include a substantially arcuate profile and can include an arc length substantially greater than 180 degrees such that the fastener retaining surface 266 forms a partial circle. The channel 268 can be defined by a pair of opposing lateral surfaces 270 that extend between ends of the fastener retaining surface 266 and the outer diameter surface 250. As such, the fastener retaining surface 266, which can include an arc length forming a partial circle as provided above, can be open to and connected with the annular outer edge 254 via the channel 268, which can be defined as a slotted opening formed by opposing lateral surfaces 270 extending between and interconnecting the ends of the interior fastener retaining surface 266 with the outer diameter surface 250 to thus define each of the outer through-holes 258 as a substantially key-hole shaped notch.

In a substantially consistent manner, the fastener retaining surface 267 of each inner through-hole 260 as shown in the embodiment illustrated in FIG. 4 can include a substantially arcuate profile and can include an arc length substantially greater than 180 degrees such that the fastener retaining surface 267 forms a partial circle. The channel 269 can be defined by a pair of opposing lateral surfaces 271 that extend between ends of the fastener retaining surface 267 and the inner diameter surface 252. As such, the fastener retaining surface 267, which can include an arc length forming a partial circle as provided above, can be open to and connected with the annular inner edge 256 via the channel 269, which can be defined as a slotted opening formed by opposing lateral surfaces 271 extending between and interconnecting the ends of the interior fastener retaining surface 267 with the inner diameter surface 252 to thus define each of the inner through-holes 260 as a substantially key-hole shaped notch.

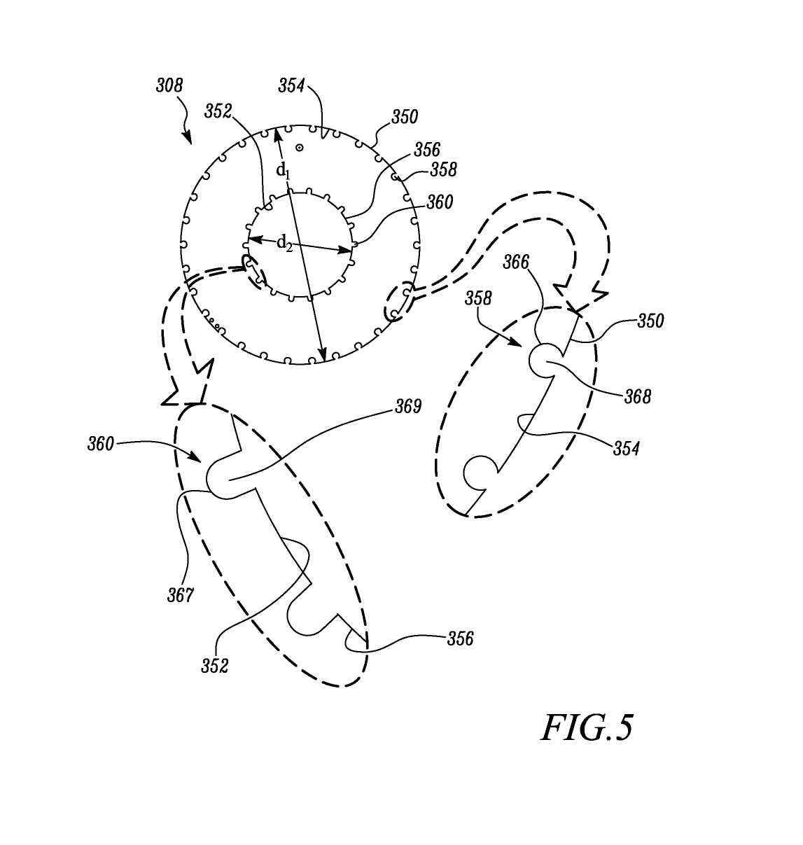

FIG. 5 illustrates a front view of the cover plate 308, according to yet another embodiment of the present disclosure. A detailed view of the outer diameter surface 350 of the cover plate 308 is provided for ease of explanation herein. The fastener retaining surface 366 of each outer through-hole 358 as shown in the embodiment illustrated in FIG. 5 can be an arcuate surface including an arc length of greater than 180 degrees to form a partial circle with ends which can be directly connected with the outer diameter surface 350 on opposing sides of the channel 368 (i.e., omitting lateral surfaces 170, 220). Thus, each of the outer through-holes 358 of the embodiment shown in FIG. 5 can be defined as a substantially horse-shoe shaped notch. In a substantially similar manner, the fastener retaining surface 367 of each inner through-hole 360 as shown in the embodiment illustrated in FIG. 5 can be an arcuate surface including an arc length of greater than 180 degrees to form a partial circle with ends which can be directly connected with the inner diameter surface 352 on opposing sides of the channel 369 (i.e., omitting lateral surfaces 171, 221). Thus, each of the inner through-holes 360 of the embodiment shown in FIG. 5 can be defined as a substantially horse-shoe shaped notch.

In the foregoing embodiments, the profile of each of the outer through-holes 158, 258, 358 and each of the inner through-holes 160, 260, 360 is explained to be forming a U-shaped notch, a key-hole shaped notch, or a horse-shoe shaped notch. However, it is to be noted that a combination of the depicted cross-sections may be interchangeably provided on the inner diameter surface 152 and the outer diameter surface 150 of the cover plate 108, 208, and 308. For example, the outer through-holes 158 may be U-shaped, while the inner through-holes 160 may be key-hole shaped. Further, a person ordinarily skilled in the may contemplate other suitable cross-sections that may be used in lieu of the U-shaped notch, the key-hole shaped notch, or the horse-shoe shaped notch, such as, but not limited to, a rectangular notch, a polygonal notch and the like, for implementation of the present disclosure.

### INDUSTRIAL APPLICABILITY

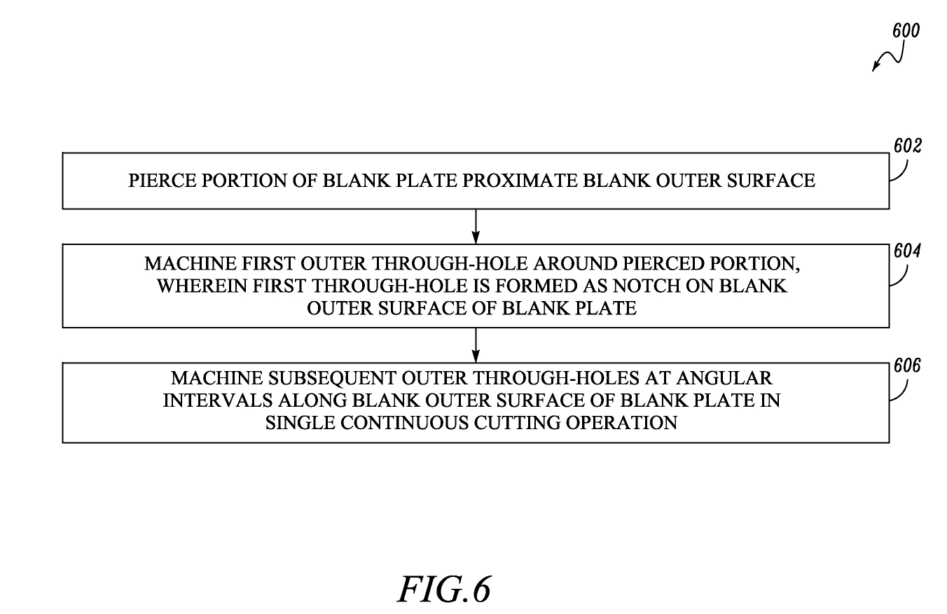

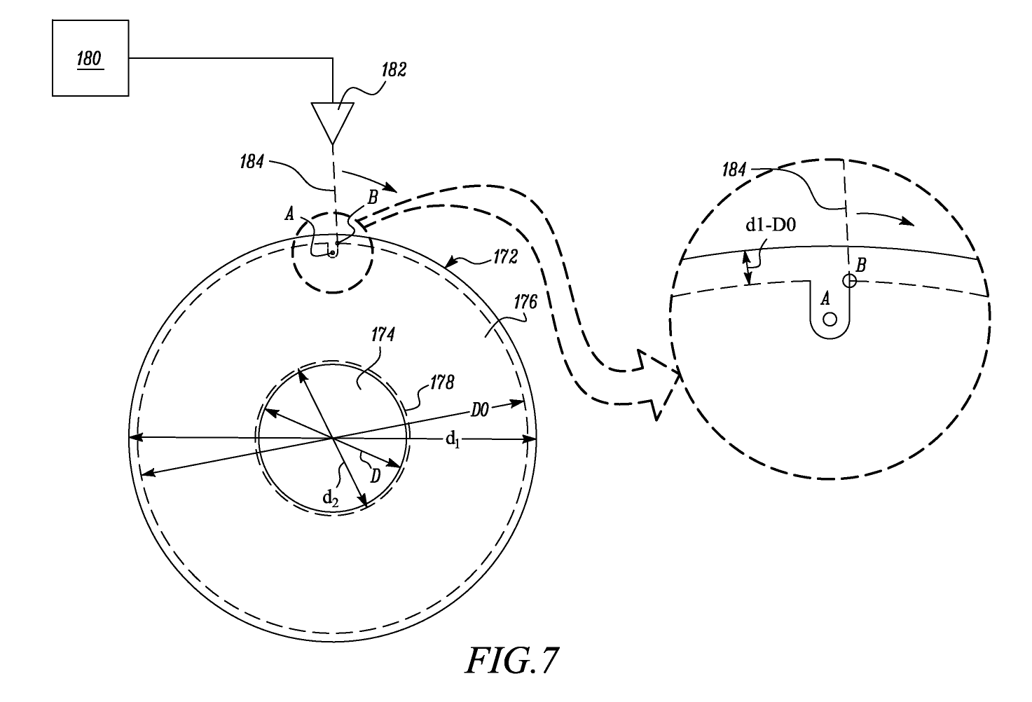

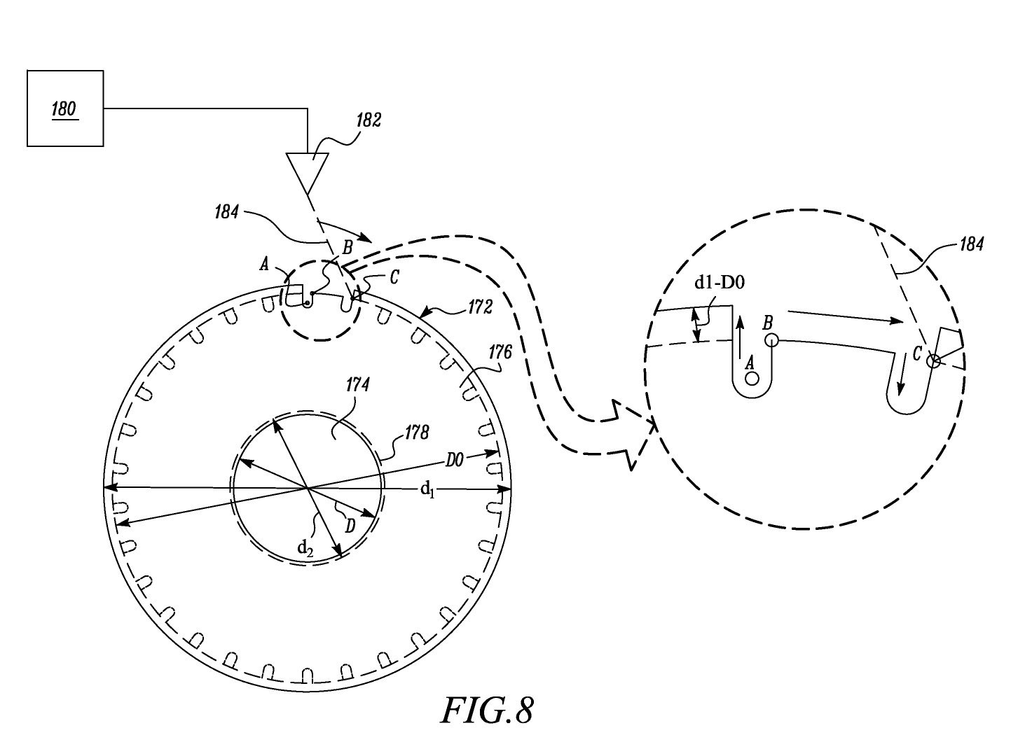

The outer diameter surface 150, 250, 350 of the foregoing embodiments of the cover plate 108, 208, 308 which can define the annular outer edge 154, 254, 354 as well as each of the plurality of fastener-receiving outer through-holes 158, 258, 358 formed as notches extending inward therefrom according to any of the foregoing embodiments can be formed by a single, continuous cutting operation, as further provided herein. Additionally, and similarly, the inner diameter surface 152, 252, 352 of the foregoing embodiments of the cover plate 108, 208, 308 which can define the annular inner edge 156, 256, 356 as well as each of the plurality of fastener-receiving inner through-holes 160, 260, 360 formed as notches extending inward therefrom according to any of the foregoing embodiments can be formed by a single, continuous cutting operation, as further provided herein. FIG. 6 illustrates a flowchart for a method of manufacturing the cover plate 108, 208, 308. FIGS. 7, 8 and 9 illustrate schematic views of an exemplary manufacturing process to manufacture the cover plate 108 (208, 308) of the present disclosure. The steps of the method as shown in FIG. 6 will be explained in conjunction to the schematic views shown in FIGS. 7, 8 and 9. For the purposes of providing a non-limiting, general illustration and description of the fabrication of the presently disclosed cover plate, the manufacturing process illustrated in FIGS. 7, 8 and 9, as well as the steps of the method as shown in FIG. 6 will be explained in conjunction thereto are shown and discussed herein as applied to the embodiment of the cover plate 108 illustrated in FIG. 2 and FIG. 3. Notwithstanding, the present disclosure is not intended to be limited thereby, as it will be understood by those of ordinary skill in the art that the method and process illustrated in FIGS. 7, 8 and 9 and discussed herein can be substantially equivalently and consistently applicable to the embodiments of the cover plates 208, 308 illustrated in FIG. 4 and FIG. 5, respectively.

In an embodiment, the cover plate 108 of the present disclosure may be formed from a blank plate 172 by using one or more commonly known machining operations such as, but not limited to laser cutting operation, water jet cutting operation, plasma cutting operation, electrical discharge machining (EDM), and the like. The blank plate 172 may include an opening 174. The opening 174 defines a blank inner diameter D. The blank plate 172 includes a blank outer surface 176 which can be concentric to a blank inner surface 178. The blank outer surface 176 defines a blank outer diameter DO which can be concentric to the blank inner diameter D. FIGS. 7, 8 and 9 illustrate use of a laser assembly 180 to machine the cover plate 108 from the blank plate 172. The laser assembly 180 includes at least one nozzle 182 configured to emit a laser beam 184. The blank plate 172 may be placed opposite the nozzle 182 such that the laser beam 184 emitted from the nozzle 182 may perform machining of the blank plate 172. The blank outer diameter DO can be greater than the outer diameter dl of the cover pate 108 to be manufactured. The detailed view of FIG. 7 illustrates the blank outer diameter DO and the outer diameter dl of the cover plate 108 (in dashed lines).

At step 602, the method includes piercing a portion of the blank plate 172 proximate the blank outer surface 176 thereof. As shown in FIG. 6, the laser beam 184 pierces a hole at a point A, proximate the blank outer surface 176. An assist gas may be provided in conjunction to the laser beam 184 to perform the piercing operation. At step 604, the method includes machining a first outer through-hole 158 around the pierced portion. The first outer through-hole 158 is formed as a notch on the blank outer surface 176 of the blank plate 172. The laser beam 184 may perform a cutting operation on the blank plate 172 to cut a semi-circle around the point A. The first outer through-hole 158 includes the fastener retaining surface 166 and the first channel 168. The first channel 168 extends from the ends of the fastener retaining surface 166 to the outer diameter d1 of the cover plate 108 (shown as point B). At step 608, the method includes machining the subsequent outer through-holes 158 at angular intervals along the blank outer surface 176 of the blank plate 172 in a single continuous cutting operation. With reference to FIG. 7, after point B, the laser beam 184 can travel to point C such that a portion (DO-di) of the blank plate 172 is machined off. From point C onwards, the laser beam 184 may machine the subsequent outer through-holes 158 in a similar manner, and throughout the blank outer surface 176 to form the cover plate 108 from the blank plate 172. A motion of the laser beam is depicted by respective arrows in FIGS. 7, 8, and 9.

In an embodiment, during machining of the blank plate 172 at the blank outer surface 176, the laser beam 184 may travel inwards from point C towards the blank inner surface 178 to from each of the first outer through-hole 158. The laser beam 184 may continue to follow a similar machining path to form consecutive outer through-holes 158. Alternatively, with reference to FIG. 5, if the outer through-holes 358 are shaped as horse-shoe shaped notches, the laser beam 184 may machine the blank outer surface 176 to form the horse-shoe shaped notch and travel therefrom to form subsequent notches. Thus, with the laser cutting operation as disclosed herein, the cover plate 308 is formed by a single, continuous cutting operation performed on the blank plate 172. A portion of the blank plate 172 having a width (d-D1) is machined off to form the annular outer edge 154 of the cover plate 108. Alternatively, one may contemplate other machining paths such as, but limited to, machining the blank outer surface 176 to form the first channel 168 followed by forming the fastener retaining surface 166. The laser beam 184 may then machine the blank plate 172 along the outer diameter d1 of the cover plate 108, 208 and form the subsequent fastener retaining surfaces 166, 266 and the channels 168, 268. Hence, the machining paths as explained herein are merely exemplary in nature and thus non-limiting to this disclosure. It is to be noted that any machining path that may machine a plate to form the cover plate 108, 208, 308 by a single, continuous cutting operation is understood to be within the scope of the present disclosure.

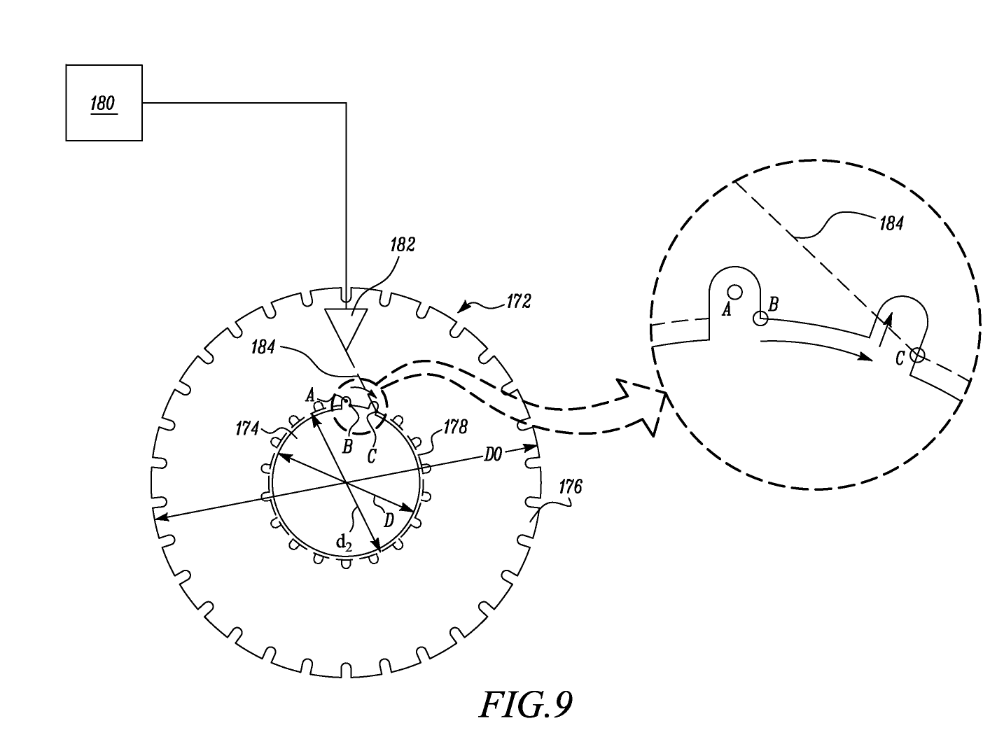

The plurality of the inner through-holes 160 are formed as notches extending inward from the annular inner edge 156. Therefore, the inner diameter surface 152, 252, 352 of the cover plate 108, 208, 308 as well as the inner through-holes 160, 260, 360 may also be formed by a single, continuous cutting operation. As shown in FIG. 9, the inner diameter surface 152 of the cover plate 108 may also be formed from the blank plate 172 by a single, continuous cutting operation in a substantially similar manner as explained for machining the outer diameter surface 150 of the cover plate 108 from the blank plate 172 in the previous embodiments. In this embodiment, the laser beam 184 may machine the inner through-holes 160 at the blank inner surface 178 by piercing a portion of the blank plate 172 proximate the blank inner surface 178. The laser beam 184 may then travel inward towards the blank outer surface 176 to form the subsequent inner through-holes 160. Further, a portion (d2-D) of the blank plate 172 may be removed to form the annular inner edge 156 of the cover plate 108. It is to be noted that with the single, continuous cutting operation as provided herein, the cover plate 108 is formed in a single step. Thus, the method of the present disclosure reduces manufacturing time and is cost effective.

Further, the cover plate 108 of the present disclosure provides for a quick and easy coupling of the cover plate 108 to the housing 106 of the crankshaft damper 102. A first fastener 162 may be partially inserted within one of the bores 114 disposed on the housing 106. The cover plate 108 may then be partly placed on the housing 106. Since the outer through-holes 158 and the inner through-holes 160 are provided as notches, the cover plate 108 may be aligned to the housing 106 by sliding the cover plate 108 over the housing 106 to receive the fastener 162 within the corresponding through-hole. Subsequent fasteners 162 may then be fastened to removably couple the cover plate 108 to the housing 106. From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A crankshaft damper for a crankshaft, the crankshaft damper comprising:
a housing comprising a center opening configured to receive the crankshaft therein;
a cover plate removably coupled to the housing, wherein the housing and the cover plate enclose an annular chamber therebetween; and
an inertia member disposed within the annular chamber;
wherein the cover plate comprises an outer diameter surface located at an outer diameter thereof, the outer diameter surface defining an annular outer edge; and
a plurality of outer through-holes formed as notches on the annular outer edge of the cover plate, wherein each of the plurality of outer through-holes extends inward along the outer diameter of the cover plate, and wherein each of the plurality of outer through-holes receives a fastener therein to couple the cover plate to the housing.

2. The crankshaft damper of claim 1, wherein each of the plurality of outer through-holes is one of a substantially horse-shoe shaped notch, a U-shaped notch, and a substantially key-hole shaped notch.

3. The crankshaft damper of claim 1, wherein each of the plurality of outer through-holes comprises a fastener retaining surface and a channel, wherein the fastener retaining surface defines a substantially arcuate profile, and wherein the channel forms an opening in the annular outer edge of the cover plate.

4. The crankshaft damper of claim 3, wherein the fastener retaining surface is substantially circular in cross-section.

5. The crankshaft damper of claim 3, wherein the channel defines a pair of opposing lateral surfaces.

6. The crankshaft damper of claim 1, wherein the housing comprises a plurality of bores extending into the interior of the housing, wherein the bores are disposed circumferentially at an external diameter thereof, and wherein each of the plurality of outer through-holes of the cover plate is aligned with each of the plurality of bores in order to receive the fastener therein.

7. The crankshaft damper of claim 1, wherein the cover plate further comprises:
an inner diameter surface located at an inner diameter thereof, the inner diameter surface defining an annular inner edge;
a plurality of inner through-holes formed as notches on the annular inner edge of the cover plate, wherein each of the plurality of inner through-holes extend outward along the inner diameter of the cover plate, and wherein each of the plurality of inner through-holes receives a fastener therein to couple the cover plate to the housing.

8. The crankshaft damper of claim 7, wherein the annular outer edge and outer diameter are substantially concentric with the annular inner edge and the inner diameter.

9. The crankshaft damper of claim 1, wherein the housing further comprising a hub defining the center opening, wherein the hub comprises a plurality of bolt-holes configured to receive respective bolts therein to couple the crankshaft to the housing.

10. A cover plate for a crankshaft damper, the cover plate comprising:
a central opening configured to receive a crankshaft therein; and
a plurality of outer through-holes formed as notches on an annular outer edge of the cover plate, wherein each of the plurality of outer through-holes extends inward along an outer diameter of the cover plate, and wherein each of the plurality of outer through-holes is configured to receive a fastener therein to couple the cover plate to a housing of the crankshaft damper.

11. The cover plate of claim 10, wherein each of the plurality of outer through-holes is one of a substantially horse-shoe shaped notch, a U-shaped notch, and a substantially key-hole shaped notch.

12. The cover plate of claim 10, wherein each of the plurality of outer through-holes comprises a fastener retaining surface and a channel, wherein the fastener retaining surface defines a substantially arcuate profile, and wherein the channel forms an opening in the annular outer edge of the cover plate.

13. The cover plate of claim 12, wherein the fastener retaining surface is substantially circular in cross-section.

14. The cover plate of claim 12, wherein the channel defines a pair of opposing lateral surfaces.

15. The cover plate of claim 10 further comprises a plurality of inner through-holes formed as notches on an annular inner edge of the cover plate, wherein each of the plurality of inner through-holes extend outward along an inner diameter of the cover plate, and wherein each of the plurality of inner through-holes is configured to receive a fastener therein to couple the cover plate to the housing.

16. The crankshaft damper of claim 15, wherein the annular outer edge and outer diameter are substantially concentric with the annular inner edge and the inner diameter.

17. A method of manufacturing a cover plate of a crankshaft damper from a blank plate, the method comprising:
piercing a portion of the blank plate proximate an blank outer surface thereof;
machining a first outer through-hole around the pierced portion, wherein the first outer through-hole is formed as a notch on the blank outer surface of the blank plate; and
machining subsequent outer through-holes at angular intervals along the blank outer surface of the blank plate in a single continuous cutting operation.

18. The method of claim 17, wherein machining the through-holes comprises one of a laser machining operation and a plasma machining operation.

19. The method of claim 17, wherein each of the plurality of outer through-holes is one of a substantially horse-shoe shaped notch, a U-shaped notch, and a substantially key-hole shaped notch.

20. The method of claim 17, further comprising the steps of:
piercing a portion of the blank plate proximate an blank inner surface thereof;
machining an inner through-hole around the pierced portion, wherein the inner through-hole is formed as a notch on the blank inner surface of the blank plate; and
machining subsequent inner through-holes at angular intervals along the blank inner surface of the blank plate in a single continuous cutting operation.
